(19) United States
(12) Patent Application Publication
(10) Pub. No.: US 2003/0097962 A1
(43) Pub. Date: May 29, 2003

(54) Hydrocolloid composition and dispersion-bound architectural formulations and emulsion paints comprising such compositions

(76) Inventors: Alexandra Hild, Walsrode (DE); Arne Henning Kull, Bomlitz (DE); Stephan Knittel, Fallingbostel (DE); Rene Kiesewetter, Wietzendorf (DE); Rudolf Kaufmann, Walsrode (DE)

Correspondence Address: BAYER CORPORATION, PATENT DEPARTMENT, 100 BAYER ROAD, PITTSBURGH, PA, 15205, US

(21) Appl. No.: 10/201,750

(22) Filed: Jul. 23, 2002

(30) Foreign Application Priority Data
Jul. 26, 2001 (DE) 10136450.4

(51) Int. Cl. C09D 101/26

(52) U.S. Cl. 106/162.81

(57) ABSTRACT

A hydrocolloid composition comprising at least one sulpoalkyl-substituted polysacharide ether, is described. More particularly, the hydrocolloid composition includes: a) at least one sulphoalkyl-substituted polysaccharide ether, which is soluble in each of cold water and hot water, e.g., carboxymethylsulphoethylcellulose (CMSEC); b) optionally at least one nonionic polysaccharide ether having a thermoreversible gel point (or cloud point) of greater than 35° C. and less than 100° C.; and c) optionally at least one additive, e.g., an antioxidant. Also described are dispersion-bound architectural formulations and emulsion paints which comprise the hydrocolloid compositions of the present invention.

### CROSS REFERENCE TO RELATED PATENT APPLICATION

The present patent application claims the right of priority under 35 U.S.C. §119 (a)-(d) of German Patent Application No. 10136450.4, filed Jul. 26, 2001.

### FIELD OF THE INVENTION

The invention relates to a hydrocolloid composition comprising at least one sulphoalkyl-substituted polysaccharide ether which is soluble in both cold and hot water, in particular carboxymethylsulphoethylcellulose (CMSEC), alone or as a physical blend with at least one hydrophobically modified nonionic polysaccharide ether which is soluble in cold water and at the same time insoluble in hot water and has a thermoreversible gel point (or cloud point) of <100° C. and >35° C. The optional hydrophobically modified nonionic polysaccharide ether may be selected from, for example, hydroxypropylcellulose ether (HPC), hydroxypropyl-hydroxyethylcellulose mixed ether (HPHEC), methylcellulose ether (MC), ethylcellulose ether (EC), methyl-hydroxyethylcellulose mixed ether (MHEC), methylhydroxypropylcellulose mixed ether (MHPC), ethyl-hydroxyethylcellulose mixed ether (EHEC) and ethyl-hydroxypropylcellulose mixed ether (EHPC). The optional hydrophobically modified nonionic polysaccharide ether may preferably be selected from methylcellulose ether, methyl-hydroxyethylcellulose mixed ether and methyl-hydroxypropylcellulose mixed ether. The present invention also relates to the use the sulphoalkyl-substituted polysaccharide ether as an additive for dispersion-bound architectural formulations, e.g., formulations for architectural purposes containing dispersion-based binders. Preferred examples of architectural formulations include, but are not limited to, synthetic-resin-bound plasters, silicate dispersion plasters and dispersion-bound coating materials, such as interior wall paints, ceiling paint and exterior wall paints, and also for silicone resin paints and silicate paints.

### BACKGROUND OF THE INVENTION

Water-soluble cellulose ethers, such as hydroxyethylcellulose (HEC), or blends of cellulose ethers, are typically used as hydrocolloids and as auxiliaries for controlling the rheology and water retention as additives for dispersion-bound architectural systems, such as, for example, for synthetic-resin-bound plasters, silicate dispersion plasters, dispersion-bound coating materials (interior wall paints, ceiling paints, exterior wall paints) and also for silicone resin paints and silicate paints. Such water-soluble cellulose ethers include, for example, hydroxyethylcellulose (HEC), hydroxypropylcellulose (HPC), hydrophobically modified hydroxyethylcellulose (hmHEC), carboxymethylcellulose (CMC), carboxymethylhydroxyethylcellulose (CMHEC), methylcellulose (MC), ethylcellulose (EC), ethylhydroxyethylcellulose (EHEC), ethylhydroxypropylcellulose (EHPC), methylhydroxyethylcellulose (MHEC) or methylhydroxypropylcellulose (MHPC). It is customary in these applications to use products of the alkylcellulose ether (MC, EC), hydroxyalkyl-alkylcellulose ether (HEMC, HPMC, HEEC, HPEC) and hydroxyethylcellulose ether (HEC) type and also hydrophobically modified hydroxyethylcellulose (hmHEC). The amounts used are generally situated within the range from about 0.3 to 0.8% by weight. When the products in question are of particularly high viscosity or comprise hydrophobically modified HEC or blends of synthetic thickeners, the amount used may also lie well below 0.3%.

It is known that the addition of cellulose ethers to paints, in particular to those paints having a high binder (dispersion) fraction, i.e., a low pigment volume concentration (PVC), results in a reduction in gloss or deterioration in gloss. One consequence of this is that in certain formulations, where the gloss requirements imposed are stringent, it is not possible to use cellulose ethers of the aforementioned kind or else their use is possible but only if further additives, such as additional binders or gloss-enhancing additives, are used. This, however, carries with it economic disadvantages for the user. Furthermore, dispersion-bound systems, such as emulsion paints, dispersion-bound tiling and filling compounds and also joint fillers and formulations referred to as ready-to-use formulations, such as “joint compounds”, and also dispersion plasters, must be able to be applied to as many different substrates as possible without any problems occurring during or after the application of the dispersion-bound system to the substrate. The requirements imposed on cellulose ethers in such formulations, although differing by region, are nevertheless generally fairly high owing to the continual onward development to the state of the art toward higher-quality products and product formulations which nevertheless remain economical. For example, one demand is that the above-mentioned systems can be applied universally without problems to a very wide variety of substrates and bind or cure even under particularly critical conditions. It is known that the application of CMC-containing formulations to gypsum filler substrates is problematic. Under certain conditions, especially critical conditions, such as poorly absorbing substrates or poorly ventilated areas or on very thin gypsum filler substrates, for example, the use of CMC-containing formulations may be accompanied by convexities in the wall covering or in the plaster or paint surface or by instances of bubbling and cracking.

### SUMMARY OF THE INVENTION

It was an object of the invention to provide hydrocolloid compositions as additives for dispersion-bound architectural formulations and emulsion paints which can be applied without problems, have no gloss reduction effect and do not lead to any problems on curing or setting even under particularly critical environment conditions (e.g., high ambient humidity, non-absorbing or poorly absorbing substrates, poor ventilation, etc.).

It has surprisingly been found that compositions of hydrocolloids comprising at least one (preferably not more than five) crosslinked or uncrosslinked sulphoalkylated polysaccharide ethers and/or sulphoalkylated polysaccharide derivatives which are soluble in both cold and hot water, alone or as a blend with at least one (preferably not more than five) crosslinked or uncrosslinked nonionic polysaccharide ethers, e.g., hydroxypropylcellulose ether (HPC), which are soluble or swellable in cold water but insoluble in hot water and have a thermoreversible gel point or cloud point of <100° C., but >35° C., achieve this object. Examples of such nonionic polysaccharide ethers include, but are not limited to, hydroxypropylcellulose ether (HPC), hydroxypropyl-hydroxyethylcellulose mixed ether (HPHEC), methylcellulose ether (MC), ethylcellulose ether (EC), methyl-hydroxyethylcellulose mixed ether (MHEC), methyl-hydroxypropylcellulose mixed ether (MHPC), ethyl-hydroxyethylcellulose mixed ether (EHEC) and ethyl-hydroxypropylcellulose mixed ether (EHPC).

In accordance with the present invention, there is provided a hydrocolloid composition comprising:

a) at least one sulphoalkyl-substituted polysaccharide ether, which is soluble in each of cold water and hot water;

b) optionally at least one nonionic polysaccharide ether having a thermoreversible gel point (or cloud point) of greater than 35° C. and less than 100° C.; and

c) optionally at least one additive.

As used herein and in the claims, the term “cold water” means water having a temperature of less than or equal to 20° C., e.g., from 15° C. to 25° C. Further as used herein and in the claims, the term “hot water” means water having a temperature of greater than 70° C., e.g., from 70° C. to 95° C.

Unless otherwise indicated, all numbers expressing quantities of ingredients, reaction conditions, etc. used in the specification and claims are to be under stood as modified in all instance by the term “about.”

### DETAILED DESCRIPTION OF THE INVENTION

By hydrocolloid compositions are meant systems which are composed of at least one (preferably not more than five) crosslinked or uncrosslinked sulphoalkyl-substituted polysaccharide ethers which are soluble in both cold and hot water, preferably alone or as a blend with at least one (preferably not more than five) nonionic polysaccharide ethers having a thermoreversible gel point (or cloud point) of <100° C., but >35° C. The group of the sulphoalkyl-substituted polysaccharide ethers soluble in both cold and hot water includes, in particular, sulphoalkylated cellulose ethers, starch ethers, and/or cyanoethers, preferably carboxymethylsulphoethylcellulose ether (CMSEC). The group of the nonionic polysaccharide derivatives having a thermoreversible gel point or cloud point of <100° C., but >35° C. includes, in particular, hydrophobically modified polysaccharide ethers which are soluble in cold water and at the same time insoluble in hot water, especially cellulose ethers, preferably hydroxyalkylcellulose ethers, hydroxyalkylcellulose mixed ethers, alkylcellulose ethers, alkylcellulose mixed ethers and alkyl-hydroxyalkylcellulose mixed ethers, with particular preference hydroxyethylcellulose mixed ethers, hydroxypropylcellulose ether, hydroxypropylcellulose mixed ethers, hydroxypropylhydroxyethylcellulose mixed ether, methylcellulose ether, ethylcellulose ether, methyl-hydroxyethylcellulose mixed ether, methyl-hydroxypropylcellulose mixed ether, ethyl-hydroxyethylcellulose mixed ether and ethyl-hydroxypropylcellulose mixed ether.

The level of the average overall degree of substitution of the sulphoalkyl-substituted polysaccharides is independent of the essence of the invention and is determined on the one hand by economic factors. On the other hand the degree of substitution is to be set as high as is necessary for the product to possess a very good solubility in water. The sulphoalkylated polysaccharides typically possess average degrees of substitution (DS) by sulphoalkyl groups, especially sulphoethyl groups, of not more than 0.6, in particular not more than 0.4, with particular preference from 0.0001 to not more than 0.3. The degree of substitution by carboxymethyl groups is typically not more 1.5, in particular not more than 1.2, with particular preference not more than 1.0.

The hydrocolloid compositions claimed in accordance with the invention are characterized in that in solution they possess viscosities of 2 mPa.s-100 000 mPa.s (rotational viscometer; shear rate D=2.55 s⁻¹, T=20° C., c=2% by weight), preferably of 10 mPa.s-50 000 mPa.s.

The preparation of the sulphoalkyl-substituted polysaccharide ethers, e.g. carboxymethylsulphoethylcellulose ether (CMSEC), and also the process for preparing the physical blends of sulphoalkyl-substituted cellulose ethers (e.g. CMSEC) with nonionic polysaccharide ethers (e.g. MC, EC, HEC, hmHEC, HPC, MHEC, MHPC, EHEC, EHPC), are known (see, for example, EP-A-0 601 403, DE-A-42 41 289, U.S. Pat. No. 2,132,181, U.S. Pat. No. 2,811,519, DE-A-3 742 106, EP-A-0 407 838).

Among sulphoalkyl-substituted polysaccharide ethers which are soluble in both cold and hot water, the ethers claimed are preferably ionic or nonionic polysaccharide ethers, such as cellulose ethers and starch ethers, especially sulphoalkylated cellulose ethers, which because of the nature and level of their degree of substitution do not have a thermal cloud point or gel point of <100° C. under atmospheric pressure, such as, for example, sulphoalkyl-substituted carboxyalkylcellulose ethers [e.g. sulphoethyl-carboxymethylcellulose (CMSEC)], sulphoalkyl-substituted hydroxyalkylcelluloses [e.g. sulphoethyl-hydroxyethylcellulose ether and sulphoethyl-hydroxypropylcellulose ether], sulphoalkylcellulose ethers [e.g. sulphoethylcellulose (SEC)], alkyl-sulphoalkylcellulose ethers [e.g. methylsulphoethylcellulose ether], alkyl-hydroxyalkyl-sulphoalkylcellulose ethers [methyl-hydroxyethyl-sulphoethylcellulose ether, methyl-hydroxypropylsulpho-ethylcellulose ether, ethyl-hydroxypropyl-sulphoethylcellulose ether, ethyl-hydroxyethyl-sulphoethylcellulose ether], hydroxyalkyl-hydroxyalkyl-sulphoalkylcellulose ethers [hydroxyethyl-hydroxypropyl-sulphoethylcellulose ether], hydroxyalkyl-hydroxyalkyl-sulphoalkylcellulose [hydroxyethyl-hydroxypropyl-sulphoethylcellulose].

By nonionic polysaccharide ethers are meant hydrophobically modified polysaccharide ethers which are soluble or swellable in cold water but at the same time insoluble in hot water and possess a thermoreversible cloud point of <100° C. but >35° C. in water under atmospheric pressure. Particular preference is given here to the following cellulose ethers: alkylcelluloses [e.g. methylcellulose, ethylcellulose], hydroxyalkylcelluloses [e.g. hydroxypropylcellulose, hydroxyethyl-hydroxypropylcellulose], alkylhydroxyalkylcellulose [e.g. methylhydroxyethylcellulose, ethylhydroxyethylcellulose, methylhydroxypropylcellulose, ethylhydroxypropylcellulose], alkylenecelluloses [such as allylcellulose], alkylenealkylcelluloses [such as allylmethylcellulose, allylethylcellulose], ternary nonionic mixed ethers, such as alkyl-hydroxyalkyl-hydroxyalkyl-celluloses [methyl-hydroxypropyl-hydroxyethylcelluloses, ethylhydroxy-propyl-hydroxyethylcelluloses] and alkylhydroxy-alkylcelluloses or hydroxyalkylcelluloses which are hydrophobically modified with long-chain alkyl radicals. Particular preference is given to using nonionic cellulose ethers, such as hydroxypropylcelluloses (HPC), ethyl-hydroxyethyl-celluloses (EHEC), ethyl-hydroxypropyl-celluloses (EHPC), methyl-hydroxyethylcelluloses (MHEC) and methyl-hydroxypropylcelluloses (MHPC).

In the hydrocolloid composition the fraction of the polysaccharide ether or polysaccharide ether blend a) that is soluble in both cold and hot water, based on the sum of the overall hydrocolloid composition claimed in accordance with the invention, is from 100 to 1% by weight, in particular from 100 to 5% by weight. The fraction of the nonionic polysaccharide ether or polysaccharide ether blend b) that is insoluble in both cold and hot water, based on the sum of the overall hydrocolloid composition claimed in accordance with the invention, is therefore in the range from 0 to 99% by weight, in particular from 0 to 95% by weight.

In one particularly preferred embodiment the hydrocolloid composition is composed of carboxymethylsulphoethylcellulose and/or carboxymethylsulphoethylstarch, alone or as a blend with methylhydroxyethylcellulose, ethylhydroxyethylcellulose, methylhydroxypropylcellulose, ethylhydroxypropylcellulose, hydroxypropylcellulose, hydroxyethyl-hydroxypropylcellulose and/or hydrophobically modified hydroxyethylcellulose.

The concept of the cloud point (flocculation point) refers to substance-specific properties of the polysaccharide ethers, particularly cellulose ethers, which are used in the hydrocolloid composition, these properties being well known to the person skilled in the art and hence requiring no further elucidation [see, for example, Reinhard Dönges, British Polymer Journal 23 (1990) pp. 315-326].

The inventively claimed hydrocolloid compositions may additionally comprise further additives, such as swelling agents, wetting agents, dispersants, grinding aids, surface-active components, film-forming auxiliaries, retardants, preservatives, antioxidants, antistats, flame retardants, fluidifiers, humectants, processing aids, pigments and fillers, defoamers, fibres (cellulose fibres or synthetic fibres), matting agents, plasticizers, optical brighteners and synthetic binders.

Where it is desired on performance grounds to crosslink the individual components of the hydrocolloid composition reversibly, i.e. to give them delayed hydrophobicity in order to bring about a temporarily retarded dissolution, in order, for example, to permit rapid, lump-free dispersion in water or aqueous systems, this can be done in a known manner using monofunctional, difunctional and/or polyfunctional compounds, such as hydroxycarboxylic acids, aldehydes and the like, especially glyoxal, with the addition of catalytic amounts of acids, such as glyoxylic acid, with or without the addition of what are known as acid-based buffer systems, e.g. phosphate buffers. Examples of known crosslinking agents are acids and anhydrides, aldehydes, such as formaldehyde, or dialdehydes, such as glyoxal.

A reversible hydrophobicization effected preferably using aldehydes can be controlled by the degree of crosslinking, in other words by the nature and amount of crosslinking reagent added and the catalyst used. The hydrophobicization or temporary crosslinking and the temporary water-insolubility of the hydrocolloid blend that is brought about as a result of this is removed in aqueous systems by intensive stirring or of itself simply by the level of alkali that is generally present in architectural systems. It is also possible to bring about a targeted increase in this level of alkali, or to accelerate it, by means of stepwise alteration, e.g. increase, in the pH. When using a phosphate buffer system consisting of a 1:1 mixture of disodium hydrogen phosphate and sodium dihydrogen phosphate, the amount used may be, for example, 0.3% by weight of the phosphate buffer system relative to the cellulose ether or cellulose ether mixture that is to be crosslinked (in each case calculated as absolutely dry material). The phosphate buffer system and the glyoxal are generally used in aqueous solution form in order to ensure homogeneous dispersion in the system. One of the ways in which the amount of reversible water-insolubility to be established can be controlled is by way of the amount of glyoxal, and it can be adapted to the specific requirements. Amounts of 1-1000 mmol of glyoxal and/or 10-500 mmol of glyoxal relative to 1 kg of phosphate buffer system relative to the cellulose ether or cellulose ether mixture to be crosslinked (in each case calculated as absolutely dry material) are customary. All of this, however, is state of the art and is not explicitly claimed by the present invention.

In the preparation of the crosslinked or uncrosslinked hydrocolloid blend claimed in accordance with the invention, organic or aqueous-organic swelling agents or water as a swelling agent may be used as additives. By swelling agents are meant compounds which lead to swelling of the hydrocolloid blend. As the swelling agents it is preferred to use water or aqueous-alcoholic solutions, such as methanol-water or ethanol-water mixtures or the like. The swelling agent is used preferably in an amount of from 10 to 80% by weight, with particular preference in an amount of from 15 to 60% by weight, based on the overall amount of the ionic and/or nonionic polysaccharide ethers present in the hydrocolloid composition.

The process for preparing the hydrocolloid composition claimed in accordance with the invention is economically simple and ecologically unobjectionable, since the swelling agent used is preferably water. The swelling agent, preferably water, may be added to a pre-prepared mixture composed of polysaccharide ether or polysaccharide ether blend a) alone or together with b). The crosslinking agent, where used, may be added alone, or with some or all of the water it is intended to add, to the hydrocolloid composition and/or to the polysaccharide ether or ethers or blends thereof. In order to provide a homogeneous mixture of the above-mentioned uncrosslinked or reversibly crosslinked hydrocolloid composition claimed in accordance with the invention it is necessary to ensure effective thorough mixing. Suitable mixing equipment comprises closed mixing vessels with moving parts, continuous mixing units, pneumatic fluid-bed mixers, rotating mixing vessels, or mixers with rotating mixer tools, etc. In order to avoid agglomeration or separation, it is also possible to combine the mixing operation with a grinding operation, to prepare premixes or to promote homogenization by weftability with additives such as surfactants or water. Suitable apparatus for this purpose includes, for example, kneading apparatus, moist-material mixers, granulating drums, pelletizing plates or pelletizing drums. The residence time in the mixing unit is dependent among other things on the kneading forces which prevail in the apparatus used. A time of from 15 to 180 minutes is preferred. The above hydrocolloid blend claimed in accordance with the present invention is processed—that is, dried and ground—in conventional manner.

The level of the water retention capacity of the sulphoethylated polysaccharide ethers is determined essentially by the degree of sulphoalkyl, especially sulphoethyl, substitution. The examples set out later on below show that using even small amounts of sulphoalkylating reagent when preparing the sulphoalkylated polysaccharide ether is sufficient to bring about a marked improvement in the performance properties. Setting degrees of substitution by sulphoalkyl or sulphoethyl groups of >0.6 is therefore neither necessary on performance grounds nor sensible on processing and economic grounds. Preferred compounds which transfer sulphoalkyl groups are chloroethanesulphonic acid, bromoethanesulphonic acid, vinylsulphonic acid and the salts thereof, especially the sodium salts.

The invention further provides dispersion-bound architectural formulations which comprise the above-described hydrocolloid compositions of the invention. In particular these architectural formulations may also comprise organic polymer dispersions, polymer emulsions as binders alone or fractions of organic binders with inorganic binders, e.g. waterglass. Architectural formulations of this kind are preferably synthetic-resin-bound dispersion plasters, silicate dispersion plasters, dispersion-based tile adhesives, dispersion-bound filling compounds or joint fillers, and dispersion-bound flooring compounds.

The invention additionally provides emulsion paints for interior and exterior walls, comprising the hydrocolloid compositions of the invention.

The invention further embraces the use of hydrocolloid compositions of the invention as additives in dispersion-bound architectural formulations or emulsion paints.

The invention is elucidated further below with reference to working examples and comparative examples.

### EXAMPLES

In the Tables and Examples set out below, indications of amounts denote parts by weight. The viscosities are measured using a rotational viscometer from Physica at a shear rate of D=2.55 s⁻¹, measuring system Z 3, and a temperature of 20° C. For determining the viscosities in aqueous solution, 2% strength by weight solutions in distilled water are subjected to measurement, unless otherwise specified. The cellulose ethers are all screened using a sieving machine with sieves according to DIN 4188 prior to their use in the emulsion paint. Fractions of 100%<0.315 mm and of not more than 40%<0.063 mm are employed.

For the performance investigations the following cellulose ethers, which typify the prior art, are used:

1. Walocel(™) CRT 20.000 GA (=reference 1) [viscosity (2% strength by weight aqueous solution) 19 800 mPas; degree of substitution by carboxymethyl groups (DS-CM): 0.91; Wolff Cellulosics GmbH & Co KG].

2. Walocel(™) XM 20.000 PV (=reference 2) [viscosity (2% strength by weight aqueous solution) 19 200 mPas; degree of substitution by methyl groups (DS-ME): 1.19; degree of substitution by hydroxy-ethyl groups (MS-HE): 0.23; Wolff Cellulosics GmbH & Co KG].

3. Walocel(™) MT 20.000 PV [viscosity (2% strength by weight aqueous solution) 20 300 mPas; degree of substitution by methyl groups (DS-ME): 1.66; degree of substitution by hydroxyethyl groups (MS-HE): 0.32; Wolff Cellulosics GmbH & Co KG].

As cellulose ethers used in accordance with the invention, two carboxymethylsulphoethylcelluloses (CMSEC) are used, on their own, and in one case a physical blend of 30% by weight CMSEC with 70% by weight Walocel(™) MT 20 000 PV (Wolff Cellulosics GmbH & Co KG).

The preparation of the carboxymethylsulphoethylcellulose ethers (CMSEC) and carboxymethylsulphoethylcellulose ether blends used in accordance with the invention is described below by way of example:

### Example 1

127 parts of processed bleached finely ground (0.02 to 0.5 mm) Linters cellulose (dry matter content 94.8%) are suspended in 2 178 parts of isopropanol under nitrogen in a thermostatable reactor with appropriate stirrer, 100 parts of a 51.3% strength aqueous solution of sodium vinylsulphonate are added, and the mixture is stirred for 15 minutes. Then 75.5 parts of sodium hydroxide pellets dissolved in 147 parts of water are added and alkalization takes place at 25 to 30° C. for 60 minutes. Over the course of 60 minutes the mixture is heated to 75° C. and the reaction temperature of 75° C. is maintained for 120 minutes. 92.3 parts of an 80% strength by weight aqueous solution of monochloroacetic acid are added dropwise to the hot reaction mixture. After a further 90 minutes at 75° C., the mixture is cooled to 25 to 30° C. and the product is filtered off and washed with five times 2 000 parts of a mixture of 3 parts water and 7 parts methanol and then with 2 000 parts of methanol. The product is dried in a forced air oven at 55° C. and then ground. The carboxymethyl-sulphoethylcellulose has a degree of substitution by sulphoethyl groups (DS-SE) of 0.24 and a degree of substitution by carboxymethyl groups (DS-CM) of 0.72. As a 2% strength by weight solution in distilled water, the product has a viscosity of 18 500 mPas (Physica rotational viscometer, D=2.55 s⁻¹, T=20° C.).

### Example 2

127 parts of processed bleached finely ground (0.02 to 0.5 mm) Linters cellulose (dry matter content 94.8%) are suspended in 2 178 parts of isopropanol under nitrogen in a thermostatable reactor with appropriate stirrer, 60 parts of a 51.3% strength aqueous solution of sodium vinyl-sulphonate are added, and the mixture is stirred for 15 minutes. Then 75.5 parts of sodium hydroxide pellets dissolved in 155 parts of water are added and alkalization takes place at 25 to 30° C. for 60 minutes. Over the course of 60 minutes the mixture is heated to 75° C. and the reaction temperature of 75° C. is maintained for 120 minutes. 92 parts of an 80% strength by weight aqueous solution of monochloroacetic acid are added dropwise to the hot reaction mixture. After a further 90 minutes at 75° C., the mixture is cooled to 25 to 30° C. During the cooling phase, while the mixture is still hot, a 1:1 mixture of 29 g of sodium dihydrogen phosphate/disodium hydrogen phosphate, as a 50% strength by weight solution in 500 g of acetone, is introduced into the reactor. 61 g of 40% strength by weight aqueous glyoxal are added to the mixture, followed by thorough stirring. The glyoxal-crosslinked crude product is separated off on a suction filter and dried in a forced air oven at 55° C. For purification, the cellulose ether is suspended twice in 4 l of water each time and in each case is separated off on a suction filter after 3 minutes. The water-moist cellulose ether is dried in a forced air oven at 55° C. and then ground. The carboxymethylsulphoethylcellulose has a degree of substitution by sulphoethyl groups (DS-SE) of 0.13 and a degree of substitution by carboxymethyl groups (DS-CM) of 0.77. As a 2% strength by weight solution in water (pH 8), the product has a viscosity of 20 100 mPas (Physica rotational viscometer, D=2.55 s⁻¹, T=20° C.). The CMSEC thus prepared can be dispersed in water without lumps.

### Example 3

A cellulose ether blend of 70% by weight glyoxal-crosslinked methylhydroxyethylcellulose (=Walocel(™) MT 20 000 PV) and 30% by weight of the glyoxal-crosslinked CMSEC designated in Example 2 is sprayed through a nozzle with 30% by weight of 80% methanol in a kneading apparatus with the kneading mechanism running. This material is kneaded for a period of 60 minutes and then dried at 105° C. to a residual moisture content of 5 to 8%. The cellulose ether mixture prepared in this way can be dispersed in water without forming lumps.

The cellulose ethers and cellulose ether blends claimed in accordance with the invention are tested by way of example in a formulation for interior wall emulsion paints. Restriction to the ingredients contained in the formulation is not associated with this. The advantages of the invention are therefore not restricted solely to emulsion paints but may also be employed in other systems, such as silicone resin paints and silicate paints, particularly dispersion-bound architectural systems, such as synthetic-resin-bound plasters, silicate dispersion plasters, dispersion-bound tile adhesives, dispersion-bound joint fillers, dispersion-bound filling compounds, dispersion-bound levelling compounds, and dispersion-bound coating materials (interior wall paints, ceiling paints, exterior wall paints) (in this respect see H. Dorr, F. Holzinger, Kronos Titandioxid in Dispersionsfarben [titanium dioxide in emulsion paints] (1989); W. Schultze, Dispersions-Silikatsysteme [silicate dispersion systems] (1994)).

Table 1 sets out the formulation for preparing the interior wall emulsion paint.

TABLE 1
Formulation of interior wall emulsion paint

| | | Amount | |
|---|---|---|---|
| No. | Ingredients | [g] | Manufacturer or Dealer |
| 1 | Water | 198.0 | — |
| 2 | Propylene glycol | 56.6 | CG Chemikalien, Laatzen, D |
| 3 | Cellulose ether *) | variable | see text |
| 4 | Byk 24⁽™⁾ | 1.9 | Byk-Chemie GmbH, Wesel, D |
| 5 | Borchigen DFN⁽™⁾ | 7.6 | Borchers GmbH, Monheim, D |
| 6 | Borchigen ND⁽™⁾ | 1.9 | Borchers GmbH, Monheim, D |
| 7 | AMP 95⁽™⁾ | 1.9 | Angus Chemie GmbH, Essen, D |
| 8 | Igepal BC-9⁽™⁾ | 2.9 | C. H. Erbslöh, Krefeld, D |
| 9 | Nuosept 95⁽™⁾ | 1.9 | Creanova, Maastricht, NL |
| 10 | Bayertitan | 188.9 | Bayer AG, Leverkusen, D |
| | RKB-4⁽™⁾ | | |
| 11 | Omyacarb Extra | 46.8 | Omya GmbH, Cologne, D |
| | CL⁽™⁾ | | |
| 12 | Water | Variable | — |
| 13 | Texanol⁽™⁾ | 16.6 | Eastman Chemical Company, |
| | | | Kingsport/USA |
| 14 | Dehydran 1293⁽™⁾ | 2.9 | Cognis GmbH, Düsseldorf, D |
| 15 | Dilexo RA3⁽™⁾ | 379.0 | Neste Chemicals GmbH, |
| | | | Moers, D |
| 16 | Total | 1000.0 | |

The cellulose ethers and cellulose ether blends used are the products Walocel(™) CRT 20 000 GA and Walocel(™) XM 20 000 PV, as products characteristic of the prior art, and also the cellulose ethers and cellulose ether mixtures identified under Example 1 to Example 3.

The procedure for preparing the emulsion paints is as follows: The formulation ingredients identified under numbers 1-8 are introduced with stirring into a 2 l water-coolable dissolver beaker, with the dissolver running at 2 000 rpm.

Subsequently, the raw materials identified under numbers 9-10 are added. The ingredients of the paint are dispersed at 4 000 rpm for 15 minutes. Then the additives identified under numbers 11-15 are introduced. The ingredients of the paint are, finally, homogenized at 2 000 rpm for a period of 10 minutes.

A concentration series is used to first determine the amount of the respective cellulose ether that is required to set a viscosity of 8 500-10 500 mPa.s in the emulsion paint. Using the paint thus obtained, different performance investigations are conducted. The results of these can be seen in Table 2.

TABLE 2
Results of the investigations in emulsion paints ¹⁾

| | | Paint 1 with | Paint 2 with | | | |
|---|---|---|---|---|---|---|
| | | Walocel⁽™⁾ | Walocel⁽™⁾ | | | Paint 5 |
| | | CRT | XM | Paint 3 | Paint 4 | with |
| | | 20.000 | 20.000 | with | with | CMSEC |
| No | Parameter | GA ²⁾ | PV ³⁾ | CMSEC ⁴⁾ | CMSEC ⁵⁾ | blend ⁶⁾ |
| 1 | Viscosity [mPas] Paint at: ⁷⁾ | | | | | |
| | D = 2.55 s⁻¹ | 10.270 | 10.380 | 9.100 | 10.210 | 9.990 |
| 2 | Viscosity [mPas] Paint at: | | | | | |
| | D = 500 s^{-1 7)} | 241 | 285 | 233 | 301 | 244 |
| | D = 10000 s^{-1 8)} | 53 | 58 | 56 | 52 | 57 |
| 3 | Stormer viscosity [KU] | 100 | 99 | 99 | 100 | 96 |
| | ASTM D 562 | | | | | |
| 4 | Splash tendency [score] ⁹⁾ | 2 | 3 | 2 | 2 | 3 |
| 5 | Film hardness [s] ¹⁰⁾ | 75 | 76 | 76 | 74 | 75 |
| 6 | Litre weight [kg/l] | 1.090 | 1.149 | 1.150 | 1.137 | 1.130 |
| 7 | Paint flow ¹¹⁾ [score] | 5 | 4-5 | 4 | 4 | 4 |
| 8 | Brushability [score] ¹³⁾ | 2- | 3 | 1-2 | 2 | 2 |
| 9 | Pigment dispersion [score] ¹⁴⁾ | 1 | 3 | 1 | 1 | 2-3 |
| 10 | Scrub resistance | ¹²⁾ | ¹²⁾ | ¹²⁾ | ¹²⁾ | ¹²⁾ |
| 11 | Gloss [%] ¹⁵⁾ at 75° | 42.1 | 31.2 | 43.0 | 42.5 | 33.5 |

Key to Table 2:
¹⁾ For procedure and formulating technique see text; for formulation see Table 1; overall amount of cellulose ether used: 0.457%
²⁾ Commercial product from Wolff Cellulosics GmbH & Co. KG (Reference 1)
³⁾ Commercial product from Wolff Cellulosics GmbH & Co. KG (Reference 2)
⁴⁾ CMSEC (invention, Example 1)
⁵⁾ CMSEC (invention, Example 2)
⁶⁾ Blend of 30% CMSEC with 70% Walocel⁽™⁾ MT 20.000 PV (invention, Example 3)
⁷⁾ Rotational viscometer Physica Z3-DIN, T = 25° C.
⁸⁾ Rotational viscometer Physica MP 31, A = 0.1 mm, T = 25° C.
⁹⁾ Splash tendency, for testing see text
¹⁰⁾ König film hardness 28 d at 64% rel. humidity, T = 20° C.
¹¹⁾ Paint flow on Leneta sheet [2.5 mm = 100%], for testing see text
¹²⁾ Double rubs; overall > 17.500 rubs
¹³⁾ Brushability, for testing see text
¹⁴⁾ With 0.5% Luconyl violet 5894, for testing see text
¹⁵⁾ Gloss measurement to DIN 54502 on 200 μm films; averages of 10 individual tests in each case, standard deviation overall about 2.2%

The performance parameters identified in Table 2 are each assessed as follows:

Paint Viscosity:

The emulsion paints investigated had their viscosities made isoviscous at 8 500-10 500 mPa.s (rotational viscometer Physica MC 20, measuring system Z 3, D=2.5 s⁻¹, T=20° C.).

Stormer Viscosity:

The Stormer viscosity was determined in accordance with ASTM-D 562. The viscosity is reported in Krebs units (KU). The purpose of determining the Stormer viscosity is to adjust the consistency of the paint to a uniform level.

To determine the Stormer viscosity, the emulsion paint is stirred up by hand for 30 seconds. The paint is then introduced into a 500 ml plastic beaker and placed centrally on the adjustable platform of the viscometer (Stormer Krebs viscometer, type 000.0407, from Mayer & Wonisch, Neheim-Huesten). The standard whisk is immersed in the paint down to the mark on the shaft. Using the weights which belong with the rheometer, it is then possible to determine precisely the weight required to achieve a revolution of 200 rpm. The standard whisk is driven by weights. The weights supplied with the viscometer range up to 1 kg, with gradations of 5 g and a minimum weight of 50 g. These weights are placed on the weight suspension means, pulled upward with the crank and let down by lowering the locking screw. In order to determine the Stormer viscosity, the required weights are counted up and expressed in Krebs units in accordance with the following table.

| Weight [g] | Krebs Units [Ku] |
|---|---|
| 400 | 104 |
| 425 | 106 |
| 450 | 108 |
| 475 | 110 |
| 500 | 112 |
| 525 | 114 |
| 550 | 116 |

Litre Weight:

Using a paint pycnometer, the density determined by way of the litre weight (specific gravity) in order to determine whether the products possess surface-active properties (foaming tendency), which could then have adverse effects in the course of further testing (assessment of the paint surface, and such like). The procedure for determining the litre weight is as follows.

The emulsion paint is stirred with a spatula spoon for 30 seconds. The emptied pycnometer (type 290 from Erichsen GmbH & Co. KG, Hemer) is weighed and filled to the brim with the paint at room temperature, avoiding air bubbles. The lid is placed on with a gentle rotational movement, and the substance emerging from the overflow hole is taken off using a rubber wiper. The filled pycnometer is then weighed again. The density is a result of the ratio of the difference in weight to the volume.

Paint Flow:

The flow property of the emulsion paint is determined using a flow testing doctor blade. The paint should normally be easy to spread. This requires a certain viscosity setting and associated flow behaviour (rheology). A coat of paint which shows brush marks which do not level out lacks optimum flow behaviour.

The Testing Procedure Was as Follows:

A glass plate is placed lengthwise on the workbench. On top of the glass plate a Leneta sheet (type 255 [dimensions: 335 mm×225 mm×0.25 mm] from Erichsen GmbH & Co. KG, Hemer) is applied. The emulsion paint under test is stirred up with a spatula spoon for 30 seconds. Immediately thereafter the paint is poured into the frame formed by the drawing sides and end faces of the doctor blade. The frame must be ⅓ full. The test doctor blade (type 419 from Erichsen GmbH & Co. KG, Hemer) is then moved at constant speed over a planar surface. The distance between the individual elements of each film stripe duo is the same to start with. The film stripes are allowed to run into one another horizontally. The distances between the individual duo elements become smaller depending on the flow properties of the paint. Evaluation is made after the paint has fully dried. The evaluation procedure is a visual assessment of the interconnects for good or poor flow behaviour. The flow testing doctor blades contain 5 gap duos each with a width of 1.6 mm, with a distance between the duo elements of 2.5 mm. In calculating the percentage flow, the middle interconnect is used as a reference variable. The area which has not flowed out is measured using a thread counter. The calculation is carried out as follows:

2.5 mm (100%)−x mm (measured)=y mm (flow)

y mm (flow)÷2.5 mm·100%=z% (=reported flow in %)

The result of test is reported as percentage flow with an associated school grade (1-6 [1=very good, 6=inadequate]) in accordance with the following guideline values:

Score 1 (>60% flow), Score 2 (52% flow), Score 3 (48% flow), Score 4 (44% flow), Score 5 (30% flow), Score 6 (<30% flow).

Pigment Dispersion:

The effect of thickeners on the dispersion of pigments in an emulsion paint is tested. For this purpose the emulsion paint is prepared with the thickener that is to be tested, and then a small amount of a critical pigment is added. The paint is then drawn down in a defined film thickness onto an uncoated piece of white card. Subsequent rubbing may give rise to further disruption of the pigment, recognizable from increased colour intensity at the site in question. The specific procedure is as follows:

The emulsion paint is prepared in accordance with the following formula:

Water: 72.3 g

Calgon N: 0.5 g

Pigment Dispersant: 0.2 g

Defoamer: 1.0 g

The following materials are then added:

Bayertitan R-D: 65.0 g

Omyacarb 2-GU: 67.5 g

Test Thickener: 1.2 g

Mixing is carried out at 1 500 rpm for 3 minutes, and then 1.5 g of ammonia (25%) and 40.0 g of Acronal 290 D are added. After stirring for a further 3 minutes, 100 g of the parent mixture are weighed out, 0.5 g of Luconyl violet 5894 is added, and stirring is carried out again for 2 minutes. The white card is placed on the glass plate and the paint is drawn down using the doctor blade. 90 seconds after drawdown, the paint film is rubbed intensively in circular motions, using the index finger, at 2 sites (duplicate determination). Evaluation is made after the paint has fully dried. A comparison is made between the colour intensity of the rubbed area and the colour intensity of the unrubbed area of the paint film. If there is no difference evident in paint intensity, it is assumed that the pigment had been fully disrupted. If the paint intensity has increased at the rubbed area in comparison with the surrounding area, then it is assumed that pigment disruption was incomplete. Scoring is undertaken on the basis of school grades from 1 to 6 (school grade 1=very good, school grade 6: inadequate).

Scrub Resistance:

The wash and scrub resistance is determined in accordance with DIN 53 778 T2 [Part 2]. The aim is to produce paint surfaces characterized by high scrub resistance values. The result is reported in double rubs. Assessment of the emulsion paint for its wash and scrub resistance is based on the principle of a time-limited exposure of a film of emulsion paint of defined dry film thickness on a defined substrate after a defined drying time to a defined cleaning liquid in a scrubber with scrubbing brushes which are moved back and forth. The test is carried out as indicated below.

In order to evaluate the paint surface and the wash and scrub resistance, paint films are produced using a semiautomatic film drawing apparatus (film drawer type 335/1 from Erichsen GmbH & Co. KG, Hemer; doctor blade 200 μm, type 335 from Erichsen). For this purpose, a paint is applied with constant wet film thickness at constant speed to a defined substrate. The specific procedure is as follows.

The film drawer is switched on, the direction switch is turned to standstill (vertical position) and the protective plate is removed. A Leneta sheet (type 255 from Erichsen GmbH & Co. KG, Hemer) is placed on the plate of the apparatus. A 200 μm doctor blade is placed in front of the blade slider. The film is fixed on the base by applying a slight vacuum (water jet pump). The emulsion paint is stirred up for 30 seconds with a spatula spoon and then introduced into the doctor blade. At a speed of advance of 19.2 mm/s, the doctor blade with the emulsion paint therein is moved over the sheet. The sheet is then placed horizontally on a worktop and dried at room temperature for 2 h.

As described (see under paint surface), the emulsion paint for testing is knifecoated onto a Leneta sheet and dried at room temperature for 28 days. For further assessment, the required amount of cleaning liquid is prepared. This is done by mixing the detergent liquid (Marion A 350, from Hüls, Marl) thoroughly using a dissolver disk at 1 500 rpm for about 3 minutes. Then a 0.25% strength solution of Marion A 350 in deionized water is prepared. The cleaning liquid is used following a storage period of 48 hours. The wash and scrub resistance is determined using a scrub tester (Model 494, from Erichsen, Hemer) with two DIN 53 777-A (Erichsen) scrubbing brushes, and also a metering pump (Model 494, from Erichsen). The emulsion paint knifecoated onto the Leneta sheet is cut to the size of the glass plate and then fastened on the rough side of the glass plate in the trough with the scrub tester, using screw clamps. The paint film is rapidly wetted with washing liquid using a brush until a layer of liquid remains on the sample coating. After one minute, any excess washing liquid is wiped off carefully using a soft, moistened sponge. After that, both brushes are brought as quickly as possible to the same wet weight and are each inserted into the brush boxes with the same narrow sides to the motor. Then the metering pump for the washing liquid is switched on; when the first drop of washing liquid emerges, the apparatus is taken into operation. In order to obtain a uniformly scrubbed sample coating suitable for evaluation, the surface of the coating must be wetted uniformly with washing liquid throughout the test. When two of the three middle tracks have been coherently scrubbed in the central area over a length 10 cm, disregarding the two outermost tracks, the test is ended. After each individual test the brushes are washed out with tap water, immersed in Marlon solution and beaten out again. The number of double rubs is then read off on the counter. If the brushes require a different number of cycles in order to expose the tracks by scrubbing, both numbers are recorded. On reaching at least 1 000 scrub cycles the paint is wash resistant, after at least 5 000 scrub cycles it is scrub resistant.

Brushability:

For determining the processability or brushability of the emulsion paint, the following procedure is used:

About 60 g of paint are placed in a 100 g plastic beaker. Using a longhair brush (bristles [China bristles] 4.5 [lacuna] long), the quality of brushability (rheology) is evaluated qualitatively on a plasterboard panel. Evaluation takes place in comparison with a standard, in the form of school grades (score 1: very good (easy brushing), score 6: inadequate (very difficult, retarded brushing)).

Splash Tendency:

The parameter tested is the effect of cellulose ethers on the splash tendency of a standard emulsion paint. For this purpose a standard emulsion paint is prepared using the cellulose ether under test. An as-new lambswool roller is wetted with a uniform amount of paint and is rolled in a precisely defined timespan over an Eternit plate under which a Leneta sheet has been placed transversely. The different number of the extent of the paint splashes, effected by different cellulose ethers, is assessed visually in comparison to the respective reference sample. The procedure here is to use the freshly prepared emulsion paints whose viscosity has been equalized. An Eternit plate is placed at an angle of 90 degrees onto a Leneta sheet. The direction of rolling is transverse with respect to the Eternit plate. Approximately 50-60 g of the paint are introduced into a painting tray and the tared lambswool roller is wetted with the paint by rolling it back and forth a few times until it has picked up 30 g±0.5 g of paint. With the stopwatch running, the lambswool roller is then rolled over the Eternit plate for 30 seconds without wetting the roller with paint again. In the course of the procedure, about 40 back-and-forth rolls should be accomplished. Rolling should be carried out with uniform pressure and at constant speed.

Evaluation is made after the paint splashes on the Leneta sheet have dried fully. An assessment is made of the extent and number of the paint splashes produced in the course of rolling. Assessment is on the basis of standardized splash cards with school grades from 1 to 6 (school grade 1=very good (no splashes), school grade 6=inadequate (a very large number of large splashes)).

The result of the investigations of the inventively claimed cellulose ethers with the emulsion paint identified in Table 1 shows that, at equal amounts used in the paint, the prior art given by Walocel(™) CRT 20 000 GA and Walocel(™) XM 20 000 PV is either matched (splash tendency, film hardness) or bettered (paint flow, brushability) by the emulsion paints identified as 3-5 which comprise CMSEC or CMSEC blends. As compared with the paint formulated using Walocel(™) XM 20 000 PV, the paints formulated with CMSEC in particular show improvements in gloss and also in pigment dispersion, which is of particular advantage in the context of the formulation of masstone paints especially.

Using the above-identified paints 1 to 5, more far-reaching investigations are conducted. In order to test whether the paints can be applied without problems even under particularly critical conditions and, furthermore, also set and cure without problems, the following investigations are conducted:

Two commercially available filling compounds of brand names UNIFLOTT (Gebruder Knauf) and VARIO (Rigips) are prepared in accordance with the manufacturer's instructions with water/solids factors of 0.37 (UNIFLOTT) and 0.50 (VARIO). On glass plates (12 cm×12 cm), which are intended to simulate the extreme case of a nonabsorbent substrate, very thin layers of filling compound are applied, drawn down to 0 mm. After the filling compounds have dried overnight at about 20° C., the above-identified paints 1 to 5 are applied thinly using a brush. In order to simulate a high ambient humidity, as prevails when interior rooms are painted with the windows closed, the glass plates coated with the paints are stored in dessicators above water for 2 days and then dried in room air (65% relative humidity, T=23° C.). When this is done it is found that only the paints formulated as paints 3 to 5 cure without blisters or cracks. The paints 1 and 2, used as standards, show complexities in the surface and also cracks and instances of delamination at the edge of the glass plates. Damage of this kind is not recorded with the paints 3, 4 and 5, formulated using CMSEC or CMSEC blends. The cellulose ethers and cellulose ether blends claimed in accordance with the invention are greatly superior here to the prior art, since they make it possible for the user to apply paints without problems or damage even to especially critical substrates (e.g. thin gypsum filling compound substrates, such as occur when Rigips boards are coated with filling compound in practice) and under particularly critical conditions (high ambient humidity, poor drying conditions, poorly absorbent substrates).

The claimed, sulphoethyl-modified cellulose ethers, especially carboxymethylsulphoethylcellulose ether (CMSEC), are used as thickeners for dispersion-bound architectural formulations and possess the advantage that, especially in those systems with a high binder fraction or dispersion fraction, i.e. low pigment volume concentration (PVC), do not reduce the gloss, exhibit excellent pigment dispersion (rub-out) and at the same time can be applied without problems even to particularly critical substrates, such as, for example, to gypsum filler compound substrates, and even under critical drying and curing conditions.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A hydrocolloid composition comprising:
a) at least one sulphoalkyl-substituted polysaccharide ether, which is soluble in each of cold water and hot water;
b) optionally at least one nonionic polysaccharide ether having a thermoreversible gel point of greater than 35° C. and less than 100° C.; and
c) optionally at least one additive.

2. The hydrocolloid composition of claim 1 wherein said sulphoalkyl-substituted polysaccharide ether (a) is selected from at least one of sulphoalkylated cellulose ethers, sulphoalkylated starch ethers and sulphoalkylated guar ethers.

3. The hydrocolloid composition of claim 1 wherein said sulphoalkyl-substituted polysaccharide ether (a) is selected from carboxyalkylsulphoalkylcellulose ethers.

4. The hydrocolloid composition of claim 1 wherein said nonionic polysaccharide ether (b) is selected from at least one of cellulose ethers, starch ethers and guar ethers.

5. The hydrocolloid composition of claim 1 wherein said nonionic polysaccharide ether (b) is a hydrophobically modified cellulose ether selected from at least one of hydroxyalkylcellulose ether, hydroxyalkylcellulose mixed ether, alkylcellulose ether, alkylcellulose mixed ether and alkyl-hydroxyalkylcellulose mixed ether type.

6. The hydrocolloid composition of claim 1 wherein said nonionic polysaccharide ether (b) is a hydrophobically modified cellulose ether selected from at least one of methylcellulose ether, methylhydroxyethylcellulose and methylhydroxypropylcellulose type.

7. The hydrocolloid composition of claim 1 wherein said additive is selected from at least one of swelling agents, wetting agents, dispersants, grinding aids, surface-active components, film-forming auxiliaries, retardants, preservatives, antioxidants, antistats, flame retardants, fluidifiers, humectants, processing aids, pigments, fillers, defoamers, fibres, matting agents, plasticizers, optical brighteners and synthetic binders.

8. A dispersion-bound architectural formulation comprising the hydrocolloid composition of claim 1.

9. The dispersion-bound architectural formulation of claim 8 further comprising, (i) an organic binder selected from organic polymer dispersions, organic polymer emulsions and organic polymer suspensions, and (ii) optionally at least one inorganic binder.

10. The dispersion-bound architectural formulation of claim 9 wherein the architectural formulation is selected from a synthetic-resin-bound dispersion plaster, a silicate dispersion plaster, a dispersion-based tile adhesive, a dispersion-bound filling compound, a dispersion-bound joint filler and a dispersion-bound flooring compound.

11. An emulsion paint comprising the hydrocolloid composition of claim 1.

12. A method of using the hydrocolloid composition of claim 1 comprising:
(i) providing the hydrocolloid composition of claim 1; and
(ii) incorporating the hydrocolloid composition of claim 1 as an additive in at least one of a dispersion-bound architectural formulation and an emulsion paint.
